(19) United States
(12) Patent Application Publication
(10) Pub. No.: US 2024/0111230 A1
(43) Pub. Date: Apr. 4, 2024

(54) IMAGE FORMING APPARATUS

(71) Applicant: SHARP KABUSHIKI KAISHA, Osaka (JP)

(72) Inventor: Toshichika KIMURA, Osaka (JP)

(21) Appl. No.: 18/244,470

(22) Filed: Sep. 11, 2023

(30) Foreign Application Priority Data
Sep. 30, 2022 (JP) 2022-158564

(51) Int. Cl. G03G 15/20

(52) U.S. Cl. CPC G03G 15/2017

(57) ABSTRACT

An image forming apparatus includes a fixing mechanism that fixes a toner image on a sheet, a pair of sheet feeding rollers that feeds the sheet while nipping the sheet between a first roller and a second roller, and one or more water droplet removing members disposed around the first roller.

### CROSS-REFERENCE TO RELATED APPLICATION

The present application claims priority from Japanese Application JP2022-158564, the content to which is hereby incorporated by reference into this application.

### BACKGROUND OF THE INVENTION

### 1. Field of the Invention

The disclosure relates to an image forming apparatus image forming apparatus that fixes a toner image on a sheet.

### 2. Description of the Related Art

An electrophotographic image forming apparatus image forming apparatus includes a fixing device that fixes a toner image on a sheet by heating and melting a toner. When the sheet is heated at the time of heating the toner, moisture contained in the sheet evaporates and water vapor is generated. When the generated water vapor condenses on a feed roller, a water droplet may adhere to a subsequently fed sheet, which causes an image defect. Therefore, a technique of suppressing the influence of condensation has been studied.

### SUMMARY OF THE INVENTION

A known image forming apparatus includes a fixing device that fixes a toner image on a sheet by heating and a pair of feed rollers that nips and feeds the sheet. The pair of feed rollers is a pair of roller bodies fixed to a rotary shaft. A helical groove is formed in an outer peripheral surface of at least one of the roller bodies. When the pair of feed rollers rotate while no sheet is fed, moisture adhering to the groove of the roller body is caused to flow out in the axial direction of the rotary shaft and removed from the outer peripheral surface of the roller body.

However, in the image forming apparatus image forming apparatus, since the moisture is merely caused to flow out from the outer peripheral surface to an end surface of the roller body, the moisture may remain adhered to the roller body. Thus, there is a problem in that the moisture may once again move to the outer peripheral surface and adhere to a sheet.

The disclosure has been made to solve the above-described problem, and an object thereof is to provide an image forming apparatus that can remove water droplets to prevent an image defect caused by wetting.

An image forming apparatus according to the disclosure includes a fixing mechanism that fixes a toner image on a sheet by applying heat and pressure, a pair of sheet feeding rollers that feeds the sheet while nipping the sheet between a first roller and a second roller, and one or more water droplet removing members disposed around the first roller and that remove a water droplet from an outer peripheral surface of the first roller.

In the image forming apparatus according to the disclosure, the pair of sheet feeding rollers may be disposed on a downstream side of the fixing mechanism in a sheet feeding direction.

In the image forming apparatus according to the disclosure, the one or more water droplet removing members may be disposed below the first roller.

In the image forming apparatus according to the disclosure, the one or more water droplet removing members may be disposed sideward of the first roller.

In the image forming apparatus according to the disclosure, the one or more water droplet removing members may be disposed with a gap from the outer peripheral surface of the first roller.

In the image forming apparatus according to the disclosure, the one or more water droplet removing members may be disposed in contact with the outer peripheral surface of the first roller.

In the image forming apparatus according to the disclosure, the one or more water droplet removing members may hold back a water droplet adhering to the outer peripheral surface of the first roller.

In the image forming apparatus according to the disclosure, the one or more water droplet removing members may absorb a water droplet adhering to the outer peripheral surface of the first roller.

In the image forming apparatus according to the disclosure, the one or more water droplet removing members may break up a water droplet adhering to the outer peripheral surface of the first roller.

In the image forming apparatus according to the disclosure, the one or more water droplet removing members may each have a sheet shape with an end portion extending toward the outer peripheral surface of the first roller.

In the image forming apparatus according to the disclosure, the one or more water droplet removing members may each have a block shape including an opposing surface opposing the outer peripheral surface of the first roller.

In the image forming apparatus according to the disclosure, the one or more water droplet removing members may each have a comb-tooth shape including an opposing surface opposing the outer peripheral surface of the first roller and a recess provided in the opposing surface.

In the image forming apparatus according to the disclosure, the one or more water droplet removing member may each have a brush shape including a plurality of projections extending toward the outer peripheral surface of the first roller.

In the image forming apparatus according to the disclosure, a sheet passing region through which a sheet passes may be set in advance at the pair of sheet feeding rollers in an axial direction of the pair of sheet feeding rollers, and the one or more water droplet removing members may each be equal to or greater in length in the axial direction than the sheet passing region.

In the image forming apparatus according to the disclosure, the first roller may be rotatably supported in a swingable manner, and the one or more water droplet removing members may move in conjunction with the first roller in the same direction.

According to the disclosure, the one or more water droplet removing members provided as members separate from the first roller remove water droplets generated on the outer peripheral surface of the first roller formed by condensation, and thus an image defect due to wetting of a sheet can be prevented.

### BRIEF DESCRIPTION OF THE DRAWINGS

FIG. 1 is a schematic side view of an image forming apparatus according to a first embodiment of the disclosure.

FIG. 2 is an enlarged schematic side view illustrating the vicinity of a fixing device in FIG. 1.

FIG. 3 is an enlarged side view illustrating the vicinity of a first roller in FIG. 2.

FIG. 4 is a perspective view illustrating a water droplet removing member according to the first embodiment of the disclosure.

FIG. 5 is a schematic side view illustrating a state in which the first roller is viewed from a second roller side.

FIG. 6 is an enlarged side view illustrating the vicinity of a first roller according to a second embodiment of the disclosure.

FIG. 7 is a perspective view illustrating a water droplet removing member according to the second embodiment of the disclosure.

FIG. 8 is a perspective view illustrating a water droplet removing member according to a third embodiment of the disclosure.

FIG. 9 is an enlarged side view illustrating the vicinity of a first roller according to a fourth embodiment of the disclosure.

FIG. 10 is a perspective view illustrating a water droplet removing member according to the fourth embodiment of the disclosure.

FIG. 11 is an enlarged side view illustrating the vicinity of a first roller according to a fifth embodiment of the disclosure.

### DESCRIPTION OF THE EMBODIMENTS

### First Embodiment

An image forming apparatus according to a first embodiment of the disclosure will be described below with reference to the accompanying drawings.

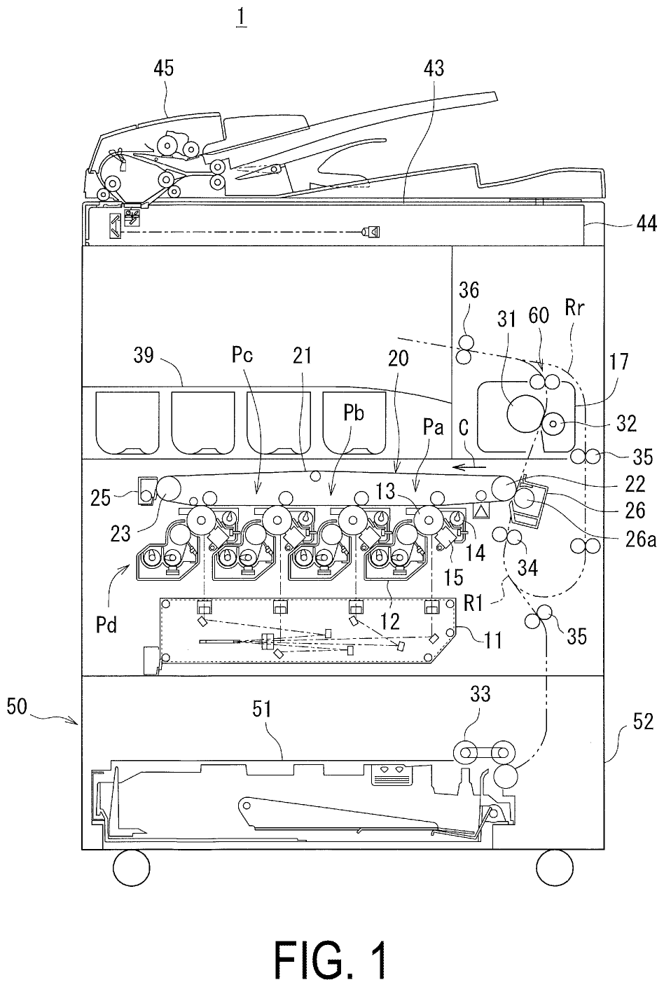

FIG. 1 is a schematic side view of an image forming apparatus according to the first embodiment of the disclosure.

An image forming apparatus 1 according to the first embodiment of the disclosure includes a main body that performs image formation, a document scanner 44 and a document feeder 45 provided in an upper part of the image forming apparatus 1, and a sheet feeding device 50 provided in a lower part of the image forming apparatus 1. The sheet feeding device 50 includes a device main body 52 and a sheet feeding cassette 51 inserted into the device main body 52.

The document scanner 44 includes, on an upper surface thereof, a document table 43 on which a document is placed. The document scanner 44 scans an image of the document on the document table 43, creates image data, and transmits the image data to the image forming apparatus 1. The document feeder 45 automatically feeds a document onto the document table 43. The document feeder 45 is pivotably attached to the image forming apparatus 1. The document feeder 45 is pivoted such that the area above the document table 43 is open, whereby a document can be manually placed on the document table 43.

The main body of the image forming apparatus 1 includes an exposure device 11, a development device 12, a photoreceptor drum 13, a cleaning device 14, a charger 15, a transfer unit 20, a fixing device 17, an output tray 39, and a sheet feeding path R1. The image forming apparatus 1 forms a color image or a black and white image on a predetermined sheet in accordance with image data transmitted from an external device or the document scanner 44.

The image data used in the image forming apparatus 1 corresponds to a color image made up of the colors black (K), cyan (C), magenta (M), and yellow (Y). Accordingly, four development devices 12, four photoreceptor drums 13, four chargers 15, and four cleaning devices 14 are provided and set to black, cyan, magenta, and yellow, respectively, to form four types of latent images corresponding to each color. Thus, four image stations Pa, Pb, Pc, and Pd are configured.

The photoreceptor drums 13 are each disposed substantially at the center of the image forming apparatus 1. The chargers 15 each uniformly charge surfaces (peripheral surfaces) of the photoreceptor drums 13 to a predetermined potential. The exposure device 11 exposes the surfaces the photoreceptor drums 13 to form electrostatic latent images. The development devices 12 each develop the electrostatic latent images on the surfaces of the photoreceptor drums 13 to form toner images on the surfaces of the photoreceptor drums 13. With this series of operations, the toner images of respective colors are formed on the respective surfaces of the photoreceptor drums 13. The cleaning devices 14 each remove and collect residual toner on the surfaces of the photoreceptor drums 13 after development and image transfer.

The transfer unit 20 includes a transfer driving roller 22, a transfer driven roller 23, and an intermediate transfer belt 21. The intermediate transfer belt 21 is suspended by the transfer driving roller 22 rotated by a connected drive source and the transfer driven roller 23, and is driven together with the transfer driven roller 23 in response to the rotation of the transfer driving roller 22. The intermediate transfer belt 21 is rotated in the direction of an arrow C, the residual toner is removed and collected by an intermediate transfer belt cleaning device 25, and the toner images of respective colors formed on the respective surfaces of the photoreceptor drums 13 are sequentially transferred and superimposed to form a color toner image on the surface of the intermediate transfer belt 21.

The image forming apparatus 1 further includes a secondary transfer device 26 including a transfer roller 26a. The transfer roller 26a forms a transfer nip region with the intermediate transfer belt 21, and a sheet fed through the sheet feeding path R1 is further fed while being nipped in the transfer nip region. When the sheet passes through the transfer nip region, the toner image on the surface of the intermediate transfer belt 21 is transferred to the sheet.

The image forming apparatus 1 performs image formation using sheets stored in the sheet feeding cassette 51. The sheet feeding device 50 is provided below the exposure device 11. The output tray 39 is provided below the document scanner 44, and is a tray on which sheets on which images have been formed are placed.

A sheet is pulled out from the sheet feeding cassette 51 by a sheet feeding roller 33 and fed to the sheet feeding path R1 which has an S-shape. Further, a feed roller 35, a registration roller 34, the secondary transfer device 26, the fixing device 17, and a sheet discharge roller 36 are disposed along the sheet feeding path R1.

The registration roller 34 temporarily holds the sheet fed from the sheet feeding cassette 51 and feeds the sheet to the transfer roller 26a at a timing at which a leading end of the toner image on the photoreceptor drum 13 and a leading end of the sheet are aligned with each other. The feed roller 35 is a small roller that promotes and assists the feeding of a sheet.

The fixing device 17 includes a fixing mechanism that fixes a toner image on a sheet by applying heat and pressure. In the present embodiment, the fixing mechanism is a mechanism including a fixing belt 31 and a pressure roller 32. The fixing mechanism receives a sheet on which an unfixed toner image is formed and fixes the toner image on the sheet by nipping the sheet between the fixing belt 31 and the pressure roller 32 and applying heat and pressure to the sheet. After the toner image is fixed, the sheet is discharged onto the output tray 39 by the sheet discharge roller 36. The fixing device 17 is of a belt fixing type, and includes a fixing pad (not illustrated) that is disposed inside of the fixing belt 31, which is an endless belt having a cylindrical shape, so as to press the fixing belt 31 from inside. Note that the fixing device 17 is not limited to the configuration described above, and may be configured such that a fixing roller including a heat source is pressed against the pressure roller 32.

In a case where an image is to be formed not only on the front side but also on the back side of a sheet, the sheet is fed in a reverse direction from the sheet discharge roller 36 to a reverse path Rr to reverse the front and back of the sheet, the sheet is guided again to the registration roller 34, an image is formed on the back side in the same manner as on the front side, and the sheet is discharged onto the output tray 39.

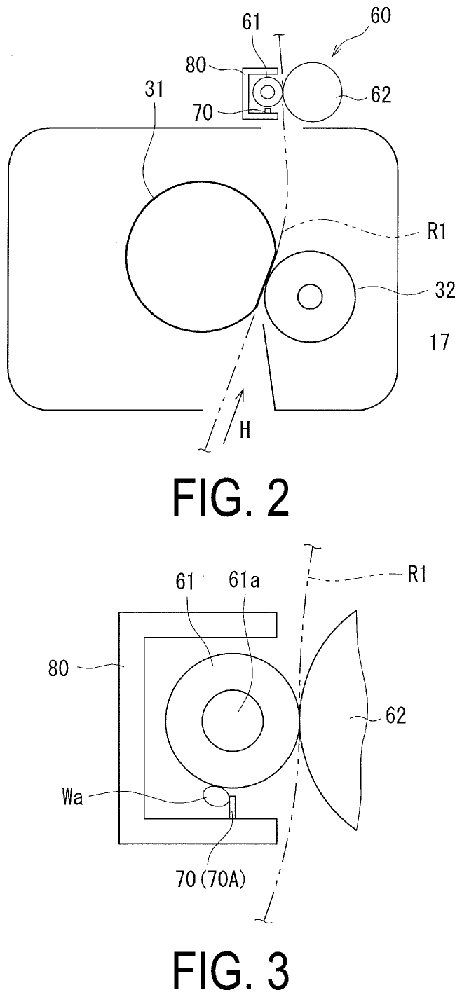

FIG. 2 is an enlarged schematic side view illustrating the vicinity of the fixing device in FIG. 1.

As described above, the fixing device 17 includes the fixing belt 31 and the pressure roller 32. In FIG. 2, a main part of the fixing device 17 is illustrated separately. However, no limitation is intended, and a heat source that heats the fixing belt 31, a fixture that supports the fixing pad, and the like may be provided. The fixing device 17 may be configured such that, instead of the fixing belt 31, a heating roller including a heat source is pressed against the pressure roller 32. When a sheet fed in a feeding direction H along the sheet feeding path R1 passes through a nip portion between the fixing belt 31 and the pressure roller 32, a toner image is fixed on the sheet.

A pair of sheet feeding rollers 60 is disposed on a downstream side of the fixing mechanism in the feeding direction H. The pair of sheet feeding rollers 60 includes a first roller 61 and a second roller 62, and feeds a sheet while nipping the sheet between the first roller 61 and the second roller 62. In FIG. 2, a roller housing 80 which is a part of the housing of the image forming apparatus 1 and is provided around the first roller 61 is illustrated separately. The roller housing 80 is provided surrounding an outer peripheral surface of the first roller 61 and is open at respective portions facing the sheet feeding path R1 and the second roller 62.

The second roller 62 is larger in diameter than the first roller 61, is connected to a drive source (not illustrated), and serves as a driving roller that is rotated by a drive force transmitted from the drive source. The first roller 61 is pressed against the second roller 62 and serves as a driven roller that is driven to rotate so as to follow the rotation of the second roller 62. Note that the disclosure is not limited thereto, and the diameters of the first roller 61 and the second roller 62 may be changed as appropriate, or one or both of the first roller 61 and the second roller 62 may be a driving roller.

In the present embodiment, the first roller 61 is a roller whose surface (outer peripheral surface) is covered with a fluororesin to prevent toner adhesion. The second roller 62 is a rubber roller having a friction coefficient higher than the friction coefficient of the first roller 61 so as to feed a sheet.

A water droplet removing member 70 that removes water droplets from the outer peripheral surface of the first roller 61 is disposed around the first roller 61. The water droplet removing member 70 is disposed below the first roller 61 and is attached to the roller housing 80.

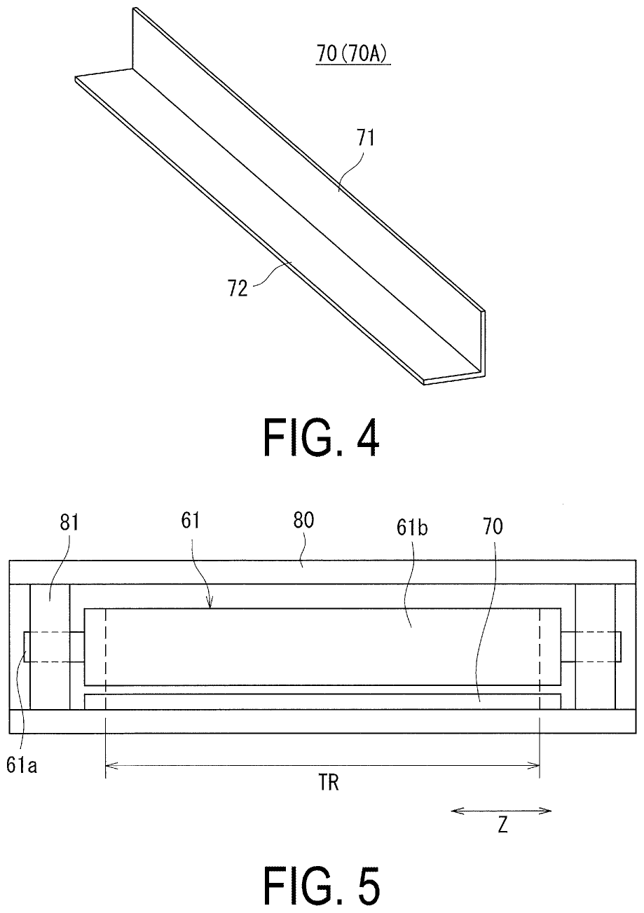

Next, the relationship between the first roller 61 and the water droplet removing member 70 will be described with reference to FIGS. 3 and 4.

FIG. 3 is an enlarged side view illustrating the vicinity of the first roller in FIG. 2, and FIG. 4 is a perspective view illustrating the water droplet removing member according to the first embodiment of the disclosure.

Water vapor generated in the fixing device 17 cools and condenses on the surface of the first roller 61. The condensed water gathers while moving along the outer peripheral surface when the first roller 61 rotates, and eventually grows into a large water droplet Wa.

The water droplet removing member 70 (first removing member 70A) according to the first embodiment extends in a rotation axis direction of the first roller 61 and has a sheet shape with an end portion extending toward the outer peripheral surface of the first roller 61. The first removing member 70A is disposed with a gap from the outer peripheral surface of the first roller 61. The gap between the first removing member 70A and the outer peripheral surface of the first roller 61 may be appropriately adjusted in accordance with the size of each member, and is set to be smaller than the large water droplet Wa. By disposing the water droplet removing member 70 slightly away from the outer peripheral surface of the first roller 61 in this manner, the water droplet removing member 70 blocks the water droplet Wa adhering to the outer peripheral surface.

When the water droplet Wa adhering to the outer peripheral surface of the first roller 61 moves along the outer peripheral surface of the first roller 61 or moves along with the rotation of the first roller 61 and reaches where the first removing member 70A is provided, the water droplet Wa is held back by the first removing member 70A. As a result, the water droplet Wa adhering to the first roller 61 moves to the first removing member 70A (roller housing 80) side so as to separate from the outer peripheral surface of the first roller 61. In the present embodiment, the first removing member 70A is disposed below the first roller 61. In other words, the water droplet removing member 70 is disposed at a location where the water droplet Wa is likely to accumulate, and thus water droplets can be efficiently removed.

As described above, the water droplet removing member 70 provided as a member separate from the first roller 61 removes the water droplet Wa generated due to condensation on the outer peripheral surface of the first roller 61, and thus an image defect due to wetting of a sheet can be prevented. In addition, since the pair of sheet feeding rollers 60 is disposed on the downstream side of the fixing mechanism in the feeding direction H, condensation on the pair of sheet feeding rollers 60 due to water vapor generated from a sheet after fixing can be appropriately addressed.

As illustrated in FIG. 4, the first removing member 70A includes a standing surface 71 extending toward the outer peripheral surface of the first roller 61 and a fixed surface 72 fixed to the roller housing 80. The standing surface 71 extends from an end portion of the fixed surface 72 so as to intersect (be orthogonal to) the fixed surface 72. By providing the fixed surface 72 in this manner, even when the first removing member 70A has a sheet shape with a small thickness, the first removing member 70A can be easily fixed to the roller housing 80. In addition, since the first removing member 70A has a sheet shape with a small thickness, it is possible to reduce friction when the first removing member 70A comes into contact with the first roller 61.

FIG. 5 is a schematic side view illustrating a state in which the first roller is viewed from the second roller side.

In the first roller 61, a rotary shaft 61a protrudes from both end portions of a roller body 61b and is rotatably supported by shaft bearings 81. The shaft bearings 81 are attached to the roller housing 80. In the pair of sheet feeding rollers 60, a sheet passing region TR through which a sheet passes is set in advance in an axial direction Z of the pair of sheet feeding rollers 60. In the present embodiment, substantially the entire roller body 61b, excluding both end portions, is set as the sheet passing region TR. That is, a sheet having a width narrower than the width of the sheet passing region TR can pass through the image forming apparatus 1.

The length of the water droplet removing member 70 in the axial direction Z is equal to or larger than the width of the sheet passing region TR and is substantially the same as the length of the roller body 61b. By providing the water droplet removing member 70 in a range that is at least the same as or wider than the sheet passing region TR in this manner, water droplets can be removed at a portion that comes into contact with the sheet.

### Second Embodiment

Next, an image forming apparatus according to a second embodiment of the disclosure will be described with reference to the accompanying drawings. Note that the image forming apparatus according to the second embodiment is substantially the same as the image forming apparatus according to the first embodiment illustrated in FIG. 1 to FIG. 5, and thus the same reference signs will be used and descriptions and drawings will be omitted.

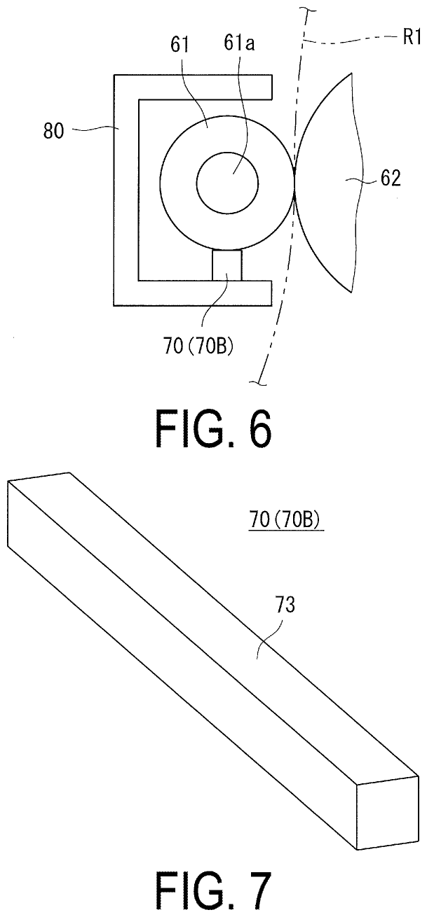

FIG. 6 is an enlarged side view illustrating the vicinity of a first roller according to the second embodiment of the disclosure, and FIG. 7 is a perspective view illustrating a water droplet removing member according to the second embodiment of the disclosure.

The second embodiment is different from the first embodiment in that the water droplet removing member 70 (a second removing member 70B) is disposed in contact with the outer peripheral surface of the first roller 61. By disposing the water droplet removing member 70 in contact with the outer peripheral surface of the first roller 61 in this manner, the water droplet removing member 70 reliably blocks water droplets adhering to the outer peripheral surface.

As illustrated in FIG. 7, the second removing member 70B has a block shape including an opposing surface 73 opposing the outer peripheral surface of the first roller 61. The second removing member 70B is formed of, for example, rubber, plastic, urethane foam, or felt, is hydrophilic, and adsorbs water droplets adhering to the outer peripheral surface of the first roller 61. When a water droplet adhering to the first roller 61 comes into contact with the water droplet removing member 70, the water droplet is adsorbed by the water droplet removing member 70, and thus the water droplet is removed from the first roller 61. Since the second removing member 70B has a thick block shape, the area blocking the water droplet can be increased and the water droplet can be reliably removed.

### Third Embodiment

Next, an image forming apparatus according to a third embodiment of the disclosure will be described with reference to the accompanying drawings. Note that the image forming apparatus according to the third embodiment is substantially the same as the image forming apparatus according to the first embodiment and the second embodiment illustrated in FIG. 1 to FIG. 7, and thus the same reference signs will be used and descriptions and drawings will be omitted.

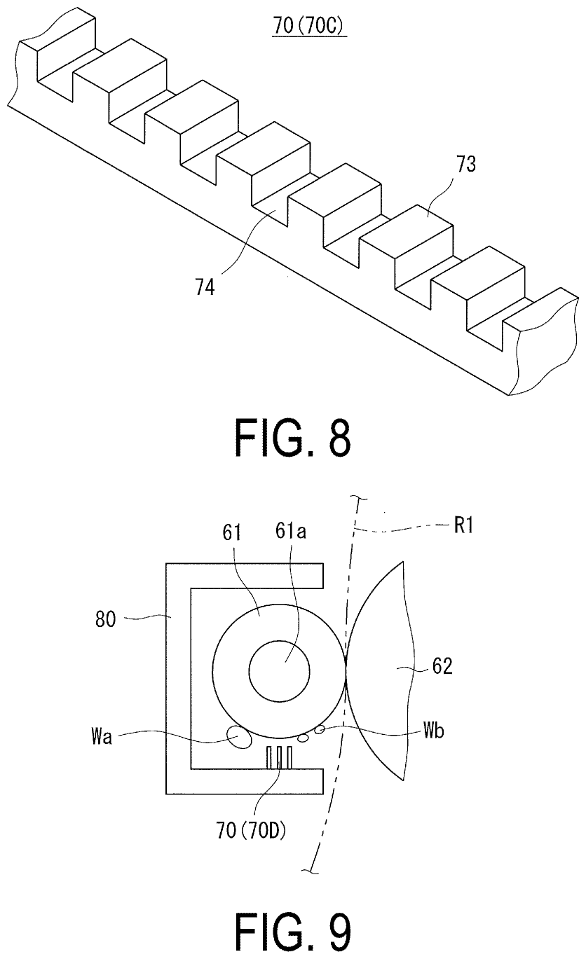

FIG. 8 is a perspective view illustrating a water droplet removing member according to the third embodiment of the disclosure.

The third embodiment differs from the second embodiment in terms of the shape of the water droplet removing member 70 (a third removing member 70C). Specifically, the third removing member 70C has a comb-tooth shape including an opposing surface 73 opposing the outer peripheral surface of the first roller 61 and recesses 74 provided in the opposing surface 73. Protrusions protruding toward the outer peripheral surface of the first roller 61 and the recesses 74 are alternately arranged in the axial direction Z. When a water droplet adhering to the outer peripheral surface of the first roller 61 comes into contact with the third removing member 70C, the water droplet is held back and moved by the protrusions, and is wiped off into the recesses 74. When the recesses 74 each have a width narrower than the width of the water droplet, the water droplet is sucked into the recesses 74 by capillary action. Accordingly, the water droplet removing performance is improved. In addition, the third removing member 70C may be formed of a material that is hydrophilic or can adsorb water. By forming the water droplet removing member 70 in a comb-tooth shape as described above, the water droplet removing member 70 can absorb a water droplet while blocking the water droplet. Thus, the water droplet can be reliably removed.

In FIG. 8, a part of the third removing member 70C is illustrated in an enlarged manner, and illustration of the other parts of the third removing member 70C is omitted. However, a configuration may be adopted in which the protrusions and the recesses 74 are arranged in the entire range in the axial direction Z, or a configuration may be adopted in which the protrusions and the recesses 74 are arranged in a partial range in the axial direction Z.

### Fourth Embodiment

Next, an image forming apparatus according to a fourth embodiment of the disclosure will be described with reference to the accompanying drawings. Note that the image forming apparatus according to the fourth embodiment is substantially the same as the image forming apparatus according to the first to third embodiments illustrated in FIG. 1 to FIG. 8, and thus the same reference signs will be used and descriptions and drawings will be omitted.

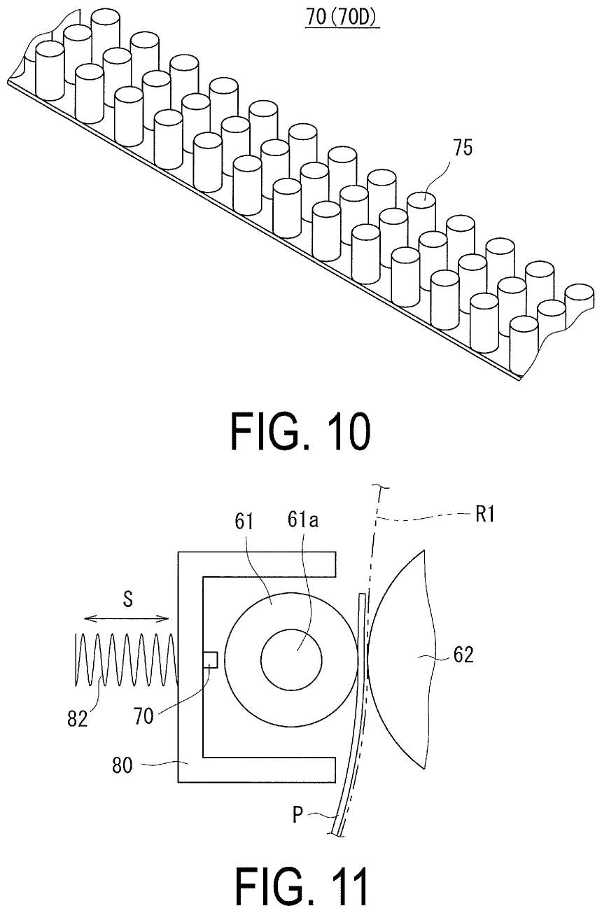

FIG. 9 is an enlarged side view illustrating the vicinity of a first roller according to the fourth embodiment of the disclosure, and FIG. 10 is a perspective view illustrating a water droplet removing member according to the fourth embodiment of the disclosure.

The fourth embodiment differs from the first embodiment in terms of the shape of the water droplet removing member 70 (a fourth removing member 70D). Specifically, the fourth removing member 70D has a brush shape including a plurality of projections 75 extending toward the outer peripheral surface of the first roller 61. FIG. 10 illustrates a configuration in which the plurality of projections 75 having the same shape are regularly arranged, but the disclosure is not limited thereto, and the projections 75 may have different sizes or may be irregularly arranged such that intervals between the projections 75 are different. In addition, the projection 75 itself may be flexible, the shape of the projection 75 may be a polygonal column shape or a cylindrical column shape, and the projection 75 may be thicker in the vicinity of a fixing portion of the projection 75 and thinner on the first roller 61 side. As illustrated in FIG. 9, the water droplet Wa adhering to the outer peripheral surface of the first roller 61 is blocked by the projections 75 or passes through between the projections 75 so as to be broken up into smaller water droplets (small water droplets Wb). After being broken up by the water droplet removing member 70, the water droplet Wa, which is large enough to affect a sheet, is removed. By forming the water droplet removing member 70 in a brush shape and providing many of the projections 75 blocking the water droplet Wa as described above, the water droplet Wa can be reliably removed.

### Fifth Embodiment

Next, an image forming apparatus according to a fifth embodiment of the disclosure will be described with reference to the accompanying drawings. Note that the image forming apparatus according to the fifth embodiment is substantially the same as the image forming apparatus according to the first to fourth embodiments illustrated in FIG. 1 to FIG. 10, and thus the same reference signs will be used and descriptions and drawings will be omitted.

FIG. 11 is an enlarged side view illustrating the vicinity of a first roller according to the fifth embodiment of the disclosure.

The fifth embodiment differs from the first embodiment in terms of the arrangement of the water droplet removing member 70. Specifically, the water droplet removing member 70 is disposed sideward of the first roller 61 and is attached to the roller housing 80. Since the water droplet removing member 70 is disposed sideward in this manner, the space below the first roller 61 can be effectively utilized. In addition, when the water droplet removing member 70 is disposed sideward, a water droplet adhering to the first roller 61 can be removed even when the area below the first roller 61 is occupied by another member due to the shape of the housing or the like.

In the present embodiment, the first roller 61 is rotatably supported in a swingable manner. That is, the shaft bearings 81 and the roller housing 80 are separated from the other parts of the housing of the image forming apparatus 1. Note that the shaft bearings 81 and the roller housing 80 may be supported by other portions of the housing so as to guide a swing direction. A biasing member 82 is attached to the roller housing 80 (or the shaft bearings 81). The biasing member 82 biases the first roller 61 via the shaft bearings 81 in a direction (one of swing directions S) in which the first roller 61 is pressed against the second roller 62. When a sheet P having a large thickness is fed by the pair of sheet feeding rollers 60, the first roller 61 swings in a direction away from the second roller 62 (the other of the swing directions S) by a distance equal to the thickness of the sheet P. Since the water droplet removing member 70 is attached to the roller housing 80, when the first roller 61 swings, the water droplet removing member 70 moves in the same direction in conjunction with the first roller 61. When the first roller 61 swings in this manner, sheets P having different thicknesses can be smoothly nipped. In addition, since the water droplet removing member 70 moves in conjunction with the first roller 61, the distance between the water droplet removing member 70 and the first roller 61 can be kept constant. As a matter of course, even when the water droplet removing member 70 is fixed to the roller housing 80 below the first roller 61, since the water droplet removing member 70 swings according to the thickness of a sheet in a similar way, the distance between the water droplet removing member 70 and the first roller 61 can be kept constant.

In the above description, the disclosure has been described as the first to fifth embodiments, but the matters described above may be combined to form different embodiments. That is, the first removing member 70A to the fourth removing member 70D may be disposed in contact with the first roller 61 or may be disposed separated from the first roller 61. Further, the water droplet removing member 70 may be disposed not only below and sideward of the first roller 61 but also above the first roller 61.

In the fifth embodiment, the shaft bearings 81 and the roller housing 80 are configured to swing. However, the roller housing 80 may be fixed and only the shaft bearings 81 (the first roller 61) may swing. In this case, when the water droplet removing member 70 is disposed below the first roller 61, the distance between the water droplet removing member 70 and the first roller 61 does not significantly vary, and thus water droplets can be removed regardless of the position of the first roller 61.

Note that the embodiments disclosed herein are illustrative in all respects and are not the basis for a limited interpretation. Accordingly, the technical scope of the disclosure is not to be construed by the foregoing embodiments only, and is defined based on the description of the claims. In addition, meanings equivalent to the range of the claims and all changes made within the range are included.

What is claimed is:

1. An image forming apparatus comprising:
a fixing mechanism that fixes a toner image on a sheet by applying heat and pressure;
a pair of sheet feeding rollers that feeds the sheet while nipping the sheet between a first roller and a second roller; and
one or more water droplet removing members disposed around the first roller and that remove a water droplet from an outer peripheral surface of the first roller.

2. The image forming apparatus according to claim 1,
wherein the pair of sheet feeding rollers is disposed on a downstream side of the fixing mechanism in a sheet feeding direction.

3. The image forming apparatus according to claim 1,
wherein the one or more water droplet removing members are disposed below the first roller.

4. The image forming apparatus according to claim 1,
wherein the one or more water droplet removing members are disposed sideward of the first roller.

5. The image forming apparatus according to claim 1,
wherein the one or more water droplet removing members are disposed with a gap from the outer peripheral surface of the first roller.

6. The image forming apparatus according to claim 1,
wherein the one or more water droplet removing members are disposed in contact with the outer peripheral surface of the first roller.

7. The image forming apparatus according to claim 1,
wherein the one or more water droplet removing members hold back a water droplet adhering to the outer peripheral surface of the first roller.

8. The image forming apparatus according to claim 1,
wherein the one or more water droplet removing members absorb a water droplet adhering to the outer peripheral surface of the first roller.

9. The image forming apparatus according to claim 1,
wherein the one or more water droplet removing members break up a water droplet adhering to the outer peripheral surface of the first roller.

10. The image forming apparatus according to claim 1,
wherein the one or more water droplet removing members each have a sheet shape with an end portion extending toward the outer peripheral surface of the first roller.

11. The image forming apparatus according to claim 1,
wherein the one or more water droplet removing members each have a block shape including an opposing surface opposing the outer peripheral surface of the first roller.

12. The image forming apparatus according to claim 1,
wherein the one or more water droplet removing members each have a comb-tooth shape including an opposing surface opposing the outer peripheral surface of the first roller and a recess provided in the opposing surface.

13. The image forming apparatus according to claim 1,
wherein the one or more water droplet removing members each have a brush shape including a plurality of projections extending toward the outer peripheral surface of the first roller.

14. The image forming apparatus according to claim 1,
wherein a sheet passing region through which the sheet passes is set in advance at the pair of sheet feeding rollers in an axial direction of the pair of sheet feeding rollers, and
the one or more water droplet removing members are equal to or greater in length in the axial direction than the sheet passing region.

15. The image forming apparatus according to claim 1,
wherein the first roller is rotatably supported in a swingable manner, and
the one or more water droplet removing members move in conjunction with the first roller in an identical direction.
